(19) United States
(12) Patent Application Publication
(10) Pub. No.: US 2023/0243340 A1
(43) Pub. Date: Aug. 3, 2023

(54) Power Generating Roof Ventilation Device

(71) Applicant: Avraham Wingarten, Chino Hills, CA (US)

(72) Inventor: Avraham Wingarten, Chino Hills, CA (US)

(21) Appl. No.: 17/590,524

(22) Filed: Feb. 1, 2022

(51) Int. Cl. F03D 9/45; F03D 3/00; F24F 7/02

(52) U.S. Cl. CPC F03D 9/45; F03D 3/005; F24F 7/025; F05B 2220/7064

(57) ABSTRACT

A power generating roof ventilation device for venting a structure and generating an electrical current includes a tube, which is mountable to a roof of a structure so that the tube is in fluidic communication with an interior space of the structure. The tube extends from the roof. A generator is engaged to and is positioned within the tube so that a drive shaft of the generator extends from the tube. A plurality of blades is engaged to the drive shaft. The blades extract energy from air passing over the blades. The drive shaft is rotated and an electrical current is generated by the generator. Simultaneously, air is extracted from the interior space of the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to roof ventilation devices and more particularly pertains to a new roof ventilation device for venting a structure and generating an electrical current. The present invention discloses a roof mountable ventilation device engaged to a turbine for generating an electrical current.

### (2) Description of Related Art Including Information Disclosed Under 37 CFR 1.97 and 1.98

The prior art relates to roof ventilation devices. The prior art comprises kits of generators to convert roof ventilators for producing electrical current, and a variety of vertical wind turbine generator/ventilator combinations. What is lacking in the prior art is roof ventilation device comprising a roof mountable ventilation device engaged to a turbine for generating an electrical current.

### BRIEF SUMMARY OF THE INVENTION

An embodiment of the disclosure meets the needs presented above by generally comprising a tube, which is configured to be mountable to a roof of a structure so that the tube is in fluidic communication with an interior space of the structure. The tube extends from the roof. A generator is engaged to and is positioned within the tube so that a drive shaft of the generator extends from the tube. A plurality of blades is engaged to the drive shaft. The blades are configured to extract energy from air passing over the blades. The drive shaft is rotated and an electrical current is generated by the generator. Simultaneously, air is extracted from the interior space of the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a power generating roof ventilation device according to an embodiment of the disclosure.

FIG. 2 is a rear view of an embodiment of the disclosure.

FIG. 3 is an isometric perspective view of an embodiment of the disclosure.

FIG. 4 is a sectional view of an embodiment of the disclosure.

FIG. 5 is a block diagram of an embodiment of the disclosure.

FIG. 6 is an in-use view of an embodiment of the disclosure.

### DETAILED DESCRIPTION OF THE INVENTION

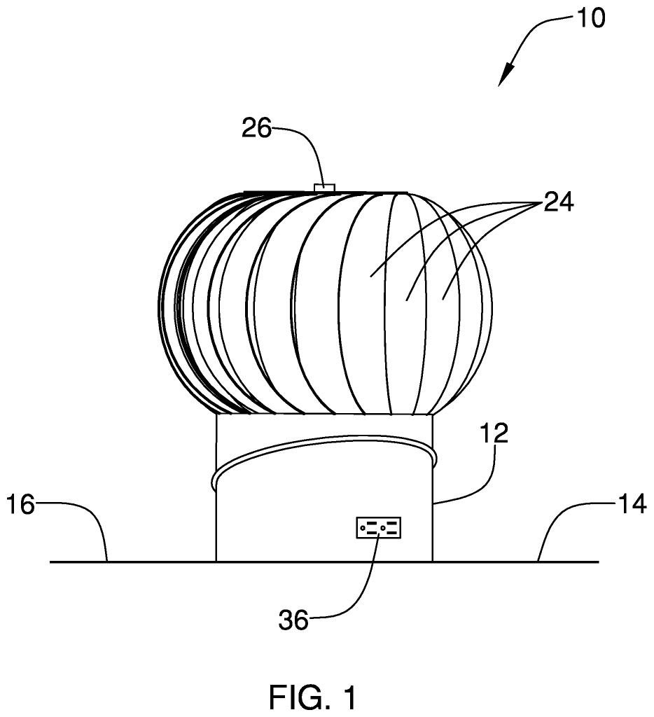

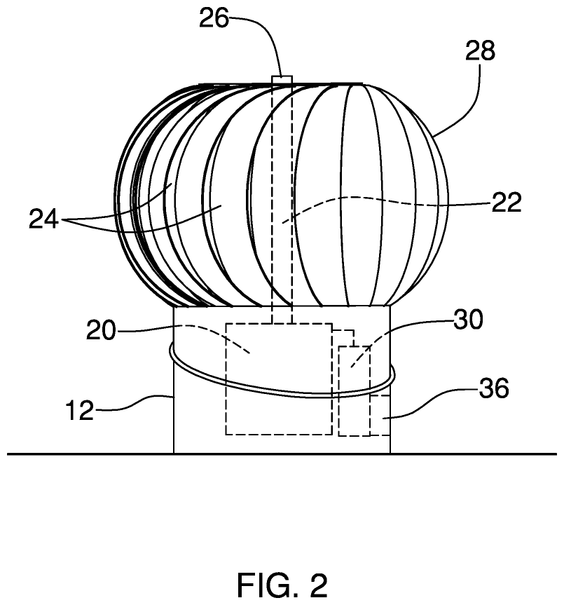

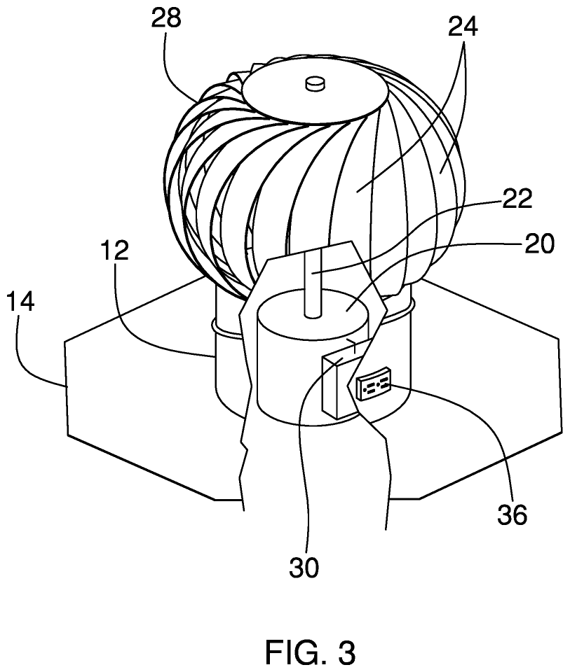

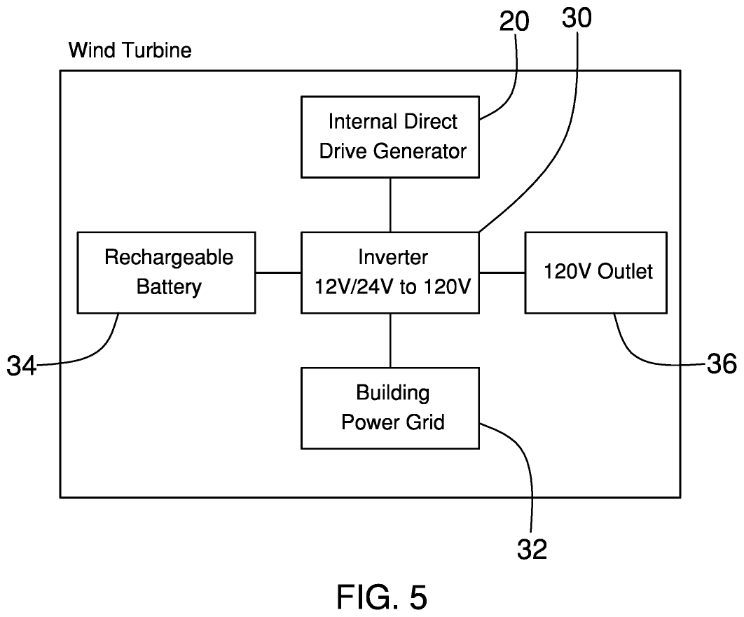

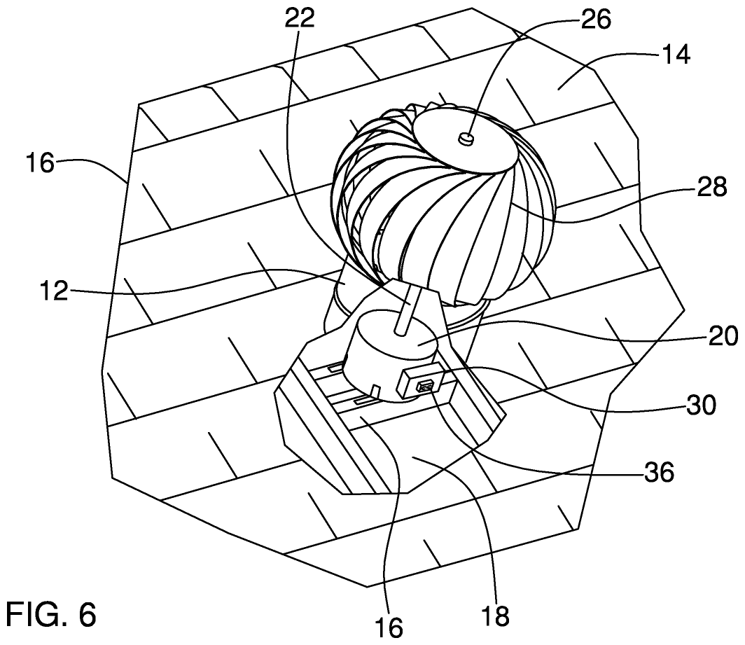

With reference now to the drawings, and in particular to FIGS. 1 through 6 thereof, a new roof ventilation device embodying the principles and concepts of an embodiment of the disclosure and generally designated by the reference numeral 10 will be described.

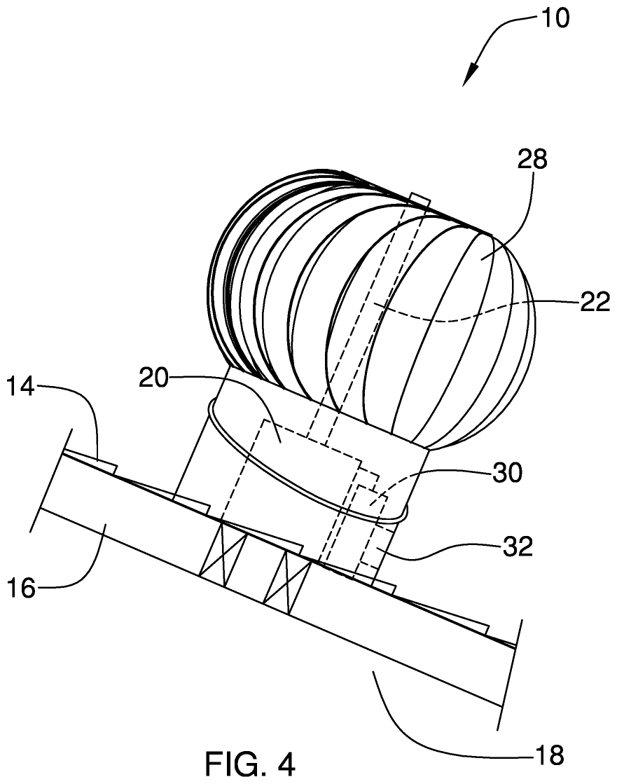

As best illustrated in FIGS. 1 through 6, the power generating roof ventilation device 10 generally comprises a tube 12, which is configured to be mountable to a roof 14 of a structure 16 so that the tube 12 is in fluidic communication with an interior space 18 of the structure 16, as shown in FIG. 4. The tube 12 extends from the roof 14. A generator 20 is engaged to and is positioned within the tube 12 so that a drive shaft 22 of the generator 20 extends from the tube 12.

A plurality of blades 24 is engaged to the drive shaft 22. The blades 24 are configured to extract energy from air passing over the blades 24. Each blade 24 extends arcuately from a terminus 26 of the drive shaft 22 toward the tube 12 so that the plurality of blades 24 is formed as a roof ventilator 28. The drive shaft 22 is rotated and an electrical current is generated by the generator 20. Simultaneously, air is extracted from the interior space 18 of the structure 16.

A power inverter 30 is operationally engaged to the generator 20. The power inverter 30 is configured to selectively convert direct current into alternating current. The power inverter 30 is configured to be operationally engaged to an electrical circuit 32 of the structure 16.

A battery 34 is operationally engaged to the power inverter 30 so that the battery 34 is chargeable by direct current passing through the power inverter 30 from the generator 20. The battery 34 is enabled to supply direct current to the power inverter 30 for conversion to alternating current.

A set of outlets 36 is engaged to the tube 12 and is operationally engaged to the power inverter 30. A respective outlet 36 is configured to be engaged to a plug of a power cord of an electrical device (not shown) to power the electrical device.

In use, the tube 12 is mounted to the roof 14 so that the tube 12 is in fluidic communication with the interior space 18. The blades 24 extract energy from the air passing over the blades 24, rotating the drive shaft 22 so that an electrical current is generated by the generator 20. Concurrently, air is extracted from the interior space 18 of the structure 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A power generating roof ventilation device comprising:
a tube configured to be mountable to a roof of a structure, such that the tube is in fluidic communication with an interior space of the structure, and such that the tube extends from the roof;
a generator engaged to and positioned within the tube, such that a drive shaft of the generator extends from the tube; and
a plurality of blades engaged to the drive shaft, wherein the blades are configured for extracting energy from air passing over the blades, such that the drive shaft is rotated and an electrical current is generated by the generator, and such that air is extracted from the interior space of the structure;
a power inverter operationally engaged to the generator, wherein the power inverter is configured for selectively converting direct current into alternating current, the power inverter being configured for operationally engaging an electrical circuit of the structure; and
a set of outlets engaged to the tube and operationally engaged to the power inverter, wherein a respective outlet is configured for engaging a plug of a power cord of an electrical device for powering the electrical device.

2. The power generating roof ventilation device of claim 1, wherein each blade extends arcuately from a terminus of the drive shaft toward the tube, such that the plurality of blades is formed as a roof ventilator.

3. (canceled)

4. The power generating roof ventilation device of claim 1, further including a battery operationally engaged to the power inverter, such that the battery is enabled for being charged by direct current passing through the power inverter from the generator, such that the battery is enabled for supplying direct current to the power inverter for conversion to alternating current.

5. (canceled)

6. A power generating roof ventilation system comprising:
a structure having a roof and defining an interior space;
a tube mounted to the roof, such that the tube is in fluidic communication with the interior space, and such that the tube extends from the roof;
a generator engaged to and positioned within the tube, such that a drive shaft of the generator extends from the tube;
a plurality of blades engaged to the drive shaft, wherein the blades are configured for extracting energy from air passing over the blades, such that the drive shaft is rotated and an electrical current is generated by the generator, and such that air is extracted from the interior space of the structure;
a power inverter operationally engaged to the generator, wherein the power inverter is configured for selectively converting direct current into alternating current, the power inverter being configured for operationally engaging an electrical circuit of the structure; and
a set of outlets engaged to the tube and operationally engaged to the power inverter, wherein a respective outlet is configured for engaging a plug of a power cord of an electrical device for powering the electrical device.

7. The power generating roof ventilation system of claim 6, wherein each blade extends arcuately from a terminus of the drive shaft toward the tube, such that the plurality of blades is formed as a roof ventilator.

8. (canceled)

9. The power generating roof ventilation system of claim 1, further including a battery operationally engaged to the power inverter, such that the battery is enabled for being charged by direct current passing through the power inverter from the generator, such that the battery is enabled for supplying direct current to the power inverter for conversion to alternating current.

10. (canceled)

11. A power generating roof ventilation device comprising
a tube configured to be mountable to a roof of a structure, such that the tube is in fluidic communication with an interior space of the structure, and such that the tube extends from the roof;
a generator engaged to and positioned within the tube, such that a drive shaft of the generator extends from the tube;
a plurality of blades engaged to the drive shaft, wherein the blades are configured for extracting energy from air passing over the blades, such that the drive shaft is rotated and an electrical current is generated by the generator, and such that air is extracted from the interior space of the structure, each blade extending arcuately from a terminus of the drive shaft toward the tube, such that the plurality of blades is formed as a roof ventilator;
a power inverter operationally engaged to the generator, wherein the power inverter is configured for selectively converting direct current into alternating current, the power inverter being configured for operationally engaging an electrical circuit of the structure;
a battery operationally engaged to the power inverter, such that the battery is enabled for being charged by direct current passing through the power inverter from the generator, such that the battery is enabled for supplying direct current to the power inverter for conversion to alternating current; and
a set of outlets engaged to the tube and operationally engaged to the power inverter, wherein a respective outlet is configured for engaging a plug of a power cord of an electrical device for powering the electrical device.
